(19) United States
(12) Patent Application Publication
(10) Pub. No.: US 2003/0214274 A1
(43) Pub. Date: Nov. 20, 2003

(54) Multiple-phase power converter having current sharing and high frequency filtering

(76) Inventor: Patrice R. Lethellier, Oxnard, CA (US)

Correspondence Address: O'MELVENY & MYERS LLP, 400 So. Hope Street, Los Angeles, CA, 90071-2899, US

(21) Appl. No.: 10/146,348

(22) Filed: May 14, 2002

(51) Int. Cl. G05F 1/56

(52) U.S. Cl. 323/272

(57) ABSTRACT

A multiple-phase power converter comprises a first inductor and a second inductor having respective input terminals and respective output terminals. The output terminals are connected together to provide a common output terminal of the multiple-phase power converter. At least a first switch circuit is connected to the input terminal of the first inductor and a second switch circuit is connected to the input terminal of the second inductor. At least one voltage source is coupled to the first and second switch circuits. A controller is adapted to control operations of the first and second switch circuits to alternately connect the input terminals of the respective inductors to the respective voltage source and ground. The controller includes an error amplifier providing a signal corresponding to a difference between respective voltage waveforms across the first and second inductors. The error amplifier includes a feedback loop providing filtering of at least one of the voltage waveforms. The controller adjusts duty cycles applied to the first and second switch circuits responsive to the signal to achieve substantially equal current in the respective inductors.

### BACKGROUND OF THE INVENTION

1. Field of the Invention

The present invention relates to voltage regulator circuits. More particularly, the invention relates to a multi-phase power converter having improved current sharing and high frequency filtering.

2. Description of Related Art

Switched mode DC-to-DC power converters are commonly used in the electronics industry to convert an available direct current (DC) level voltage to another DC level voltage. A switched mode converter provides a regulated DC output voltage to a load by selectively storing energy in an output inductor coupled to the load by switching the flow of current into the output inductor. A synchronous buck converter is a particular type of switched mode converter that uses two power switches, typically MOSFET transistors, to control the flow of current in the output inductor. A high-side switch selectively couples the inductor to a first power supply voltage while a low-side switch selectively couples the inductor to a second power supply voltage, such as ground. A pulse width modulation (PWM) control circuit is used to control the gating of the high-side and low-side switches in an alternating manner. Synchronous buck converters generally offer high efficiency and high power density, particularly when MOSFET devices are used due to their relatively low on-resistance. Therefore, synchronous buck converters are advantageous for use in providing power to electronic systems, such as microprocessors that require a control voltage (V_{cc}) of 1 to 1.5 volts with current ranging from 40 to 60 amps.

For certain applications having especially demanding current load requirements, it is known to combine plural synchronous buck converters together in multi-phase configurations operated in an interleaf mode. The output inductors of each of the multiple channels are connected together to provide a single output voltage. The PWM control circuit provides a variable duty cycle control signal to each channel in order to control its switching. The multiple channels are operated in a synchronous manner, with the respective high-side switches of each channel being switched on at different phases of a power cycle. Multi-phase configurations are advantageous in that they provide an increase in the frequency of ripple across the output voltage above the switching frequency of the individual channels, thereby enabling the use of smaller output capacitors to reduce the ripple. Also, by spreading the output current among the multiple channels, the stress on individual components of the power converter is reduced.

To regulate the performance of a multi-phase power converter, it is known to enforce current sharing between the channels so that each channel is carrying an appropriate proportion of the output current. Current sharing systems monitor the current of each channel and adjust the duty cycle to the channels to ensure an even distribution of current. One approach to monitoring the current of each channel is to include a sensing resistor in series with each respective output inductor and to monitor the voltage drop across the sensing resistor. A significant drawback of this approach is that the sensing resistors waste the output energy and thereby reduce the efficiency of the multi-phase power converter. Moreover, the sensing resistors generate heat that must be removed from the system.

Alternatively, the sensing resistors could be disposed in series with the respective high-side switches, which results in less energy dissipation than the preceding approach. But, a drawback of this approach is that the high-side switches change state at a relatively high rate (e.g., greater than 250 KHz) and, as a result, the high-side switch current is discontinuous. The information obtained from sampling the voltage across the sensing resistors must therefore be utilized during a subsequent switching cycle, making it necessary to include “sample and hold” circuitry to store the sampled information from cycle to cycle. Not only does this add complexity to the converter, but there is also a time delay in regulating the output current that diminishes the stability of the converter.

Yet another approach to measuring the channel current is to include a filter in parallel with each output inductor. The filter includes a resistor and a capacitor connected together in series. The signal passing through the output inductor has a DC component and an AC component. The AC component of the signal depends on the inductance and internal resistance values of the output inductor, as well as the resistance and capacitance of the current sensor. Through proper selection of the values of the resistor and capacitor, the instantaneous voltage across the capacitor can be made equal to the voltage across the DC resistance of the inductor and thereby proportional to the instantaneous current through the output inductor. Thus, the output inductor current can be sensed without dissipating the output energy by monitoring the voltage across the capacitor. A drawback of this approach is that the current sense signal has relatively small amplitude that is close to the noise floor and therefore highly susceptible to distortion due to high frequency noise. While the high frequency noise can be removed using low pass filters, it substantially increases the component count and complexity of the power converter to include separate low pass filters for each of the channels.

Accordingly, it would be desirable to provide an improved way to perform current sharing between channels of a multi-phase power converter. It would also be desirable to provide a current sharing system having efficient high frequency filtering of the noise on the current sense signal.

### SUMMARY OF THE INVENTION

The present invention overcomes these drawbacks of the prior art by providing a way to monitor the current in each channel of a multi-phase power converter to ensure accurately current sharing. The current sharing circuit also provides active filtering of high frequency noise on the signal sensed from the channels.

In an embodiment of the invention, a multiple-phase power converter comprises a first inductor and a second inductor having respective input terminals and respective output terminals. The output terminals are connected together to provide a common output terminal of the multiple-phase power converter. At least a first switch circuit is connected to the input terminal of the first inductor and a second switch circuit is connected to the input terminal of the second inductor. At least one voltage source is coupled to the first and second switch circuits. A controller is adapted to control operations of the first and second switch circuits to alternately connect the input terminals of the respective inductors to the respective voltage source and ground. The controller includes an error amplifier providing a signal corresponding to a difference between respective voltage waveforms across the first and second inductors. The error amplifier includes a feedback loop providing filtering of at least one of the voltage waveforms. The controller adjusts duty cycles applied to the first and second switch circuits responsive to the signal to achieve substantially equal current in the respective inductors.

In another embodiment of the invention, the controller further comprises an integrated circuit having error amplifier included therein. The integrated circuit includes external pins adapted for connection of the feedback loop between an output terminal of the error amplifier and at least one input terminal of the error amplifier. In addition to filtering high frequency noise from current share signal, the feedback loop also can be used to modify the gain and phase of the current share signal.

A more complete understanding of the method and apparatus for current sharing between channels of a multi-phase power converter will be afforded to those skilled in the art, as well as a realization of additional advantages and objects thereof, by a consideration of the following detailed description of the preferred embodiment. Reference will be made to the appended sheets of drawings that will first be described briefly.

### BRIEF DESCRIPTION OF THE DRAWINGS

FIG. 1 is a schematic diagram of a multi-phase DC-to-DC power converter in accordance with an embodiment of the invention; and

FIG. 2 is a schematic diagram of a multi-phase DC-to-DC power converter in accordance with an alternative embodiment of the invention.

### DETAILED DESCRIPTION OF THE PREFERRED EMBODIMENT

The present invention satisfies the need for a way to monitor the current in each channel of a multi-phase power converter to ensure accurately current sharing.

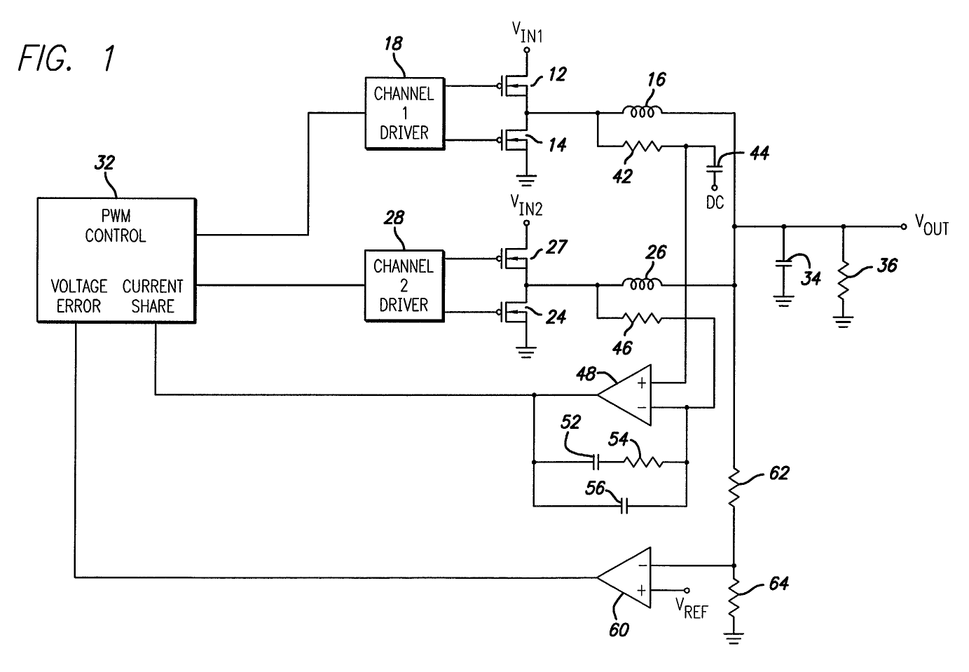

Referring first to FIG. 1, a multi-phase DC-to-DC power converter is illustrated in accordance with an embodiment of the invention. The DC-to-DC power converter provides an output voltage (V_{OUT}) to a load 36, schematically represented as a resistor. A capacitor 34 is electrically connected in parallel with the load 12 to provide smoothing of the output voltage V_{OUT}. As will be further described below, the exemplary multiphase DC-to-DC includes two channels, but it should be appreciated any number of channels could be advantageously utilized in accordance with the invention.

The first channel of the multi-phase power converter includes a high-side power switch 12 and a low-side power switch 14 connected to a first input voltage source (V_{IN1}). The high-side power switch 12 and the low-side power switch 14 are generally provided by MOSFET devices, with the drain of the high-side power switch 12 electrically connected to the first input voltage source V_{IN1}, the source of the high-side power switch 12 electrically connected to the drain of the low-side power switch 14, and the source of the low-side power switch 14 electrically connected to ground. A power phase node is defined between the source of the high-side power switch 12 and the drain of the low-side power switch 14. An output inductor 16 is connected in series between the power phase node and the load 36. A channel one driver 18 provides a series of pulse width modulated control pulses to the power switches 12, 14 to turn the power switches on and off in an alternating manner.

The second channel of the power converter has a similar construction as the first channel, and includes a high-side power switch 22 and a low-side power switch 24 generally provided by MOSFET devices and connected to a second input voltage source (V_{IN2}). A power phase node is defined between the source of the high-side power switch 22 and the drain of the low-side power switch 24. An output inductor 26 is connected in series between the power phase node and the load 36. The output inductors 16, 26 are connected together to provide a single output voltage (V_{OUT}). The first input voltage source (V_{IN1}) may be the same as the second input voltage source (V_{IN2}), or they may each be distinct voltage sources at different voltage levels. A channel two driver 28 provides a series of pulse width modulated control pulses to the power switches 22, 24 to turn them on and off in an alternating manner.

A pulse width modulation (PWM) control circuit 32 is connected to the channel one driver 18 and the channel two driver 28. The PWM control circuit 32 provides control signals to the channel one and two drivers 18, 28, which in turn regulate the output current delivered to the load 36 by controlling the timing and duration of conduction of the power switches of the first and second channels. The PWM control circuit 32 receives two feedback signals, including a voltage error signal and a current share signal. The PWM control circuit 32 uses the voltage error signal to maintain the output voltage (V_{OUT}) at a desired voltage level. A voltage error circuit includes differential amplifier 60 and a voltage divider provided by resistors 62, 64 connected in series between the output voltage (V_{OUT}) and ground. The voltage divider reduces the output voltage (V_{OUT}) to a fractional value. The differential amplifier 60 compares the divided-down output voltage (V_{OUT}) to a reference voltage (V_{REF}), and provides the voltage error signal. The PWM control circuit 32 thereby regulates the two channels in a manner that minimizes the voltage error signal.

The PWM control circuit 32 uses the current share signal to ensure that the two channels are carrying a desired proportion of the output current. A current share circuit includes a differential amplifier 48 and resistors 42, 46. Resistor 42 is connected between the power phase node of the first channel (at the input to the output inductor 16) and the non-inverting input terminal of the differential amplifier 48. Resistor 46 is connected between the power phase node of the second channel (at the input to the output inductor 26) and the inverting input terminal of the differential amplifier 48. A capacitor 44 is also connected to the non-inverting input terminal of the differential amplifier 48. The opposite end of the capacitor 44 is connected to a DC voltage. The DC voltage may be ground, output voltage (V_{OUT}), or a constant reference voltage level. The capacitor 44 serves to attenuate high frequency components of the power phase node voltage of the first channel. The differential amplifier 48 generates a current share signal that corresponds to the difference between voltages sensed at the power phase nodes at the input to the respective output inductors 16, 26. It should be appreciated that identical sensed voltages correspond to identical currents through the respective output inductors 16, 26. The PWM control circuit 32 thereby ensures current sharing by regulating the two channels in a manner that minimizes the current share signal.

The differential amplifier 48 further includes a feedback loop provided by resistor 54 and capacitor 52 connected together in series between the inverting input terminal and output terminal of the differential amplifier, and capacitor 56 connected between the inverting input terminal and output terminal of the differential amplifier. Resistor 54 and capacitor 52 provide a low pass filter that serves to trim the gain and phase of the current share signal. Capacitor 56 attenuates high frequency components of the power phase node voltage of the second channel (in a similar manner as capacitor 44 discussed above). It should be appreciated that the differential amplifier 48 provides active filtering of the current share signal by operation of the feedback loop.

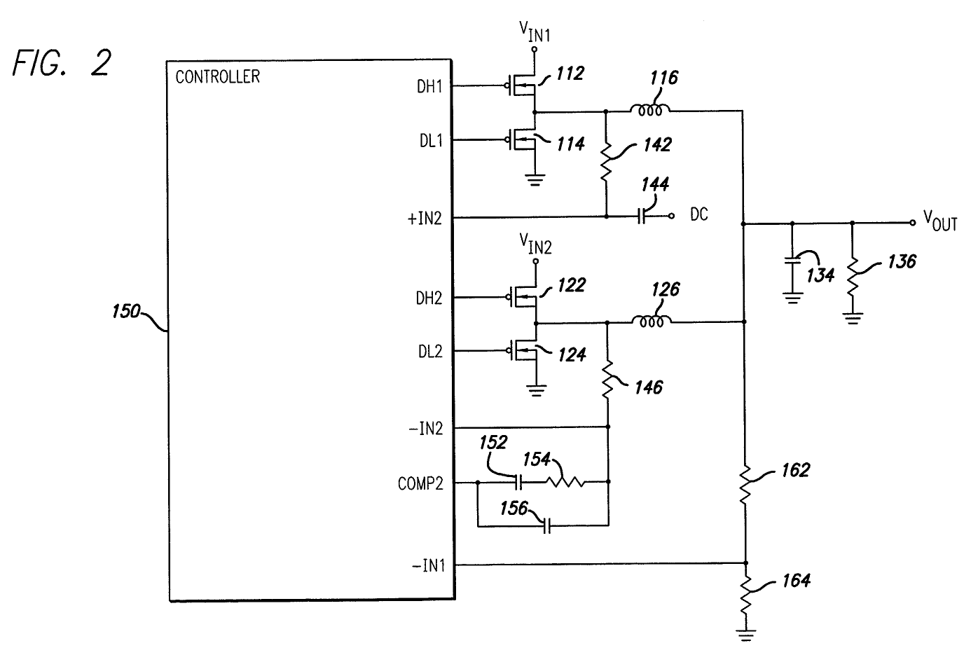

Referring now to FIG. 2, a multi-phase DC-to-DC power converter is illustrated in accordance with another embodiment of the invention. In this alternative embodiment, a controller circuit 150 provided in an integrated circuit chip is utilized, such as a commercially available dual synchronous voltage mode controller (e.g., Semtech SC2677). The controller circuit 150 includes an internal PWM control circuit and drivers for two DC-to-DC switched mode converters operated either in current sharing mode or in independent mode. The controller circuit 150 further includes two internal error amplifiers that can be trimmed externally. More specifically, the controller circuit 150 includes a first pair of high and low side gate drive pins (DH1, DL1), a second pair of high and low side gate drive pins (DH2, DL2), inverting error amplifier pins (−IN1, −IN2), a non-inverting error amplifier pin (+IN2), and a compensation pin (COMP2). The compensation pin (COMP2) is coupled to the output of the second error amplifier. The first internal error amplifier may be used for generating the voltage error signal, and the second internal error amplifier may be used for generating the current share signal.

The first channel of the multi-phase power converter includes a high-side power switch 112 and a low-side power switch 114 connected to a first input voltage source (V_{IN1}). The drain of the high-side power switch 112 is electrically connected to the first input voltage source V_{IN1}, the source of the high-side power switch 112 is electrically connected to the drain of the low-side power switch 114, and the source of the low-side power switch 114 is electrically connected to ground. An output inductor 116 is connected in series between the load 136 and a power phase node defined between the high-side and low side switches. The gate of high-side power switch 112 is connected to high-side gate drive pin DH1, and the gate of low-side power switch 114 is connected to low-side gate drive pin DL1.

The second channel includes a high-side power switch 122 and a low-side power switch 124 connected to a second input voltage source (V_{IN2}). The drain of the high-side power switch 122 is electrically connected to the second input voltage source V_{IN2}, the source of the high-side power switch 122 is electrically connected to the drain of the low-side power switch 124, and the source of the low-side power switch 124 is electrically connected to ground. An output inductor 126 is connected in series between the load 136 and a power phase node defined between the high-side and low side switches. The gate of high-side power switch 122 is connected to high-side gate drive pin DH2, and the gate of low-side power switch 124 is connected to low-side gate drive pin DL2. The output inductors 116, 126 are connected together to provide a single output voltage (V_{OUT}). The first input voltage source (V_{IN1}) may be the same as the second input voltage source (V_{IN2}), or they may each be distinct voltage sources at different voltage levels.

The controller 150 includes internal error amplifiers for generating a voltage error signal and a current share signal. A voltage divider circuit is provided by resistors 162, 164 connected in series between the output voltage (V_{OUT}) and ground. The voltage divider reduces the output voltage (V_{OUT}) to a fractional value, and applies the divided-down output voltage (V_{OUT}) to the inverting input pin of first internal error amplifier (−IN1). A current share circuit is provided by resistors 142, 146 and capacitors 144, 156. Resistor 142 is connected between the power phase node of the first channel (at the input to the output inductor 116) and the non-inverting input pin of second internal error amplifier (+IN2). Resistor 146 is connected between the power phase node of the second channel (at the input to the output inductor 126) and the inverting input pin of second internal error amplifier (−IN2). Capacitor 144 is also connected to the noninverting input pin of second internal error amplifier (+IN2). The opposite end of the capacitor 144 is connected to a DC voltage, such as ground, output voltage (V_{OUT}), or a constant reference voltage level. The capacitor 144 serves to attenuate high frequency components of the power phase node voltage of the first channel. The internal error amplifier generates a current share signal that corresponds to the difference between voltages sensed at the power phase nodes at the input to the respective output inductors 116, 126. It should be appreciated that identical sensed voltages correspond to identical currents through the respective output inductors 116, 126.

Since the output terminal of the second internal error amplifier is accessible from outside the controller 150, a feedback loop for the second internal error amplifier can be provided using external components. Resistor 154 and capacitor 152 are connected together in series between the inverting input pin (−IN2) and output pin (COMP2) of the second internal error amplifier. Also, capacitor 156 is connected between the inverting input pin (−IN2) and the output pin (COMP2) of the second internal error amplifier. Resistor 154 and capacitor 152 provide a low pass filter that serves to trim the gain and phase of the current share signal. Capacitor 156 attenuates high frequency components of the power phase node voltage of the second channel (in a similar manner as capacitor 144 discussed above). Accordingly, the feedback loop provides both functions of filtering high frequency components of the voltage sensed from the second channel and trimming the gain and phase of the current share signal.

Having thus described a preferred embodiment of a method and apparatus for providing current sharing between channels of a multi-phase power converter, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. A multiple-phase power converter, comprising:
at least a first inductor and a second inductor having respective input terminals and respective output terminals, said output terminals connected together;
at least a first switch circuit connected to said input terminal of said first inductor and a second switch circuit connected to said input terminal of said second inductor;
at least one voltage source coupled to said first and second switch circuits; and
a controller adapted to control operations of said first and second switch circuits to alternately connect said input terminals of the respective inductors to said respective voltage source and ground, said controller including an error amplifier providing a signal corresponding to a difference between respective voltage waveforms across the first and second inductors, said error amplifier including a feedback loop providing filtering of at least one of said voltage waveforms, said controller adjusting duty cycles applied to said first and second switch circuits responsive to said signal to achieve substantially equal current in the respective inductors.

2. The multiple-phase power converter of claim 1, wherein said feedback loop further provides gain and phase adjustment of said signal.

3. The multiple-phase power converter of claim 1, wherein said first and second switch circuits each further comprises a high-side switch coupled to said at least one voltage source and a low-side switch coupled to ground.

4. The multiple-phase power converter of claim 1, wherein said feedback loop further comprises at least a capacitor connected between an output terminal of said error amplifier and an inverting input terminal of said error amplifier.

5. The multiple-phase power converter of claim 1, wherein said controller further comprises an integrated circuit with said error amplifier included therein, said integrated circuit including external pins adapted for connection of said feedback loop between an output terminal of said error amplifier and at least one input terminal of said error amplifier.

6. The multiple-phase power converter of claim 1, wherein said at least one voltage source further comprises a first voltage source connected to said first switch circuit and a second voltage source connected to said second switch circuit.

7. The multiple-phase power converter of claim 6, wherein said first voltage source and said second voltage source each have different voltage levels.

8. The multiple-phase power converter of claim 6, wherein said first voltage source and said second voltage source each have the same voltage level.

9. A multiple-phase power converter with forced current sharing, comprising:
at least a first inductor and a second inductor having respective input terminals and respective output terminals, said output terminals connected together;
at least a first switch circuit connected to said input terminal of said first inductor and a second switch circuit connected to said input terminal of said second inductor;
at least one voltage source coupled to said first and second switch circuits;
means for converting voltage waveforms at respective ones of said input terminals into respective sensed voltages;
means for comparing said sensed voltages to provide a current sharing signal;
means for active filtering said current sharing signal; and
means for adjusting duty cycles of said respective voltage waveforms responsive to said current sharing signal to achieve equal sensed voltages.

10. The multiple-phase power converter of claim 9, wherein said voltage converting means further comprises sensing resistors coupled to respective ones of said input terminals.

11. The multiple-phase power converter of claim 10, wherein said comparing means further comprises an error amplifier having input terminals connected to respective ones of said sensing resistors.

12. The multiple-phase power converter of claim 11, wherein said active filtering means further a feedback loop connected between an output terminal of said error amplifier and one of said input terminals of said error amplifier.

13. The multiple-phase power converter of claim 9, wherein said first and second switch circuits each further comprises a high-side switch coupled to said at least one voltage source and a low-side switch coupled to ground.

14. The multiple-phase power converter of claim 9, wherein said at least one voltage source further comprises a first voltage source connected to said first switch circuit and a second voltage source connected to said second switch circuit.

15. The multiple-phase power converter of claim 14, wherein said first voltage source and said second voltage source each have different voltage levels.

16. The multiple-phase power converter of claim 14, wherein said first voltage source and said second voltage source each have the same voltage level.

17. In a multiple-phase power converter comprising at least a first inductor and a second inductor having respective input terminals and respective output terminals, said output terminals connected together, at least a first switch circuit connected to said input terminal of said first inductor and a second switch circuit connected to said input terminal of said second inductor, and at least one voltage source coupled to said first and second switch circuits, a method for forcing current sharing comprises the steps of:
sensing voltage waveforms at respective input terminals of said first and second inductors;
applying said sensed voltages to respective input terminals of an error amplifier;
filtering high frequency components of at least one of said voltage waveforms using a feedback loop of said error amplifier;
generating a current share signal corresponding to differences between said sensed voltages; and
adjusting duty cycles applied to said first and second switch circuits responsive to said current share signal.

18. The method of claim 17, further comprising adjusting at least one of gain and phase of said current share signal.

19. The method of claim 17, wherein said error amplifier is included within an integrated circuit adapted to control said multiple-phase power converter, and wherein said filtering step further comprises connecting said feedback loop to respective externally accessible pins of said integrated circuit corresponding to an output terminal of said error amplifier and at least one input terminal of said error amplifier.

20. The method of claim 19, wherein said filtering step further comprises connecting a capacitor between said respective externally accessible pins.
